(19) United States
(12) Patent Application Publication
(10) Pub. No.: US 2010/0010838 A1
(43) Pub. Date: Jan. 14, 2010

(54) SYSTEM AND METHOD FOR MAXIMIZING AFTER-TAX INCOME USING SPLIT METHOD CHARITABLE REMAINDER TRUSTS

(76) Inventor: Benson L. Schaub, Phoenix, AZ (US)

Correspondence Address: Kunzler & McKenzie, 8 EAST BROADWAY, SUITE 600, SALT LAKE CITY, UT, 84111, US

(21) Appl. No.: 12/502,109

(22) Filed: Jul. 13, 2009

Related U.S. Application Data
(63) Continuation-in-part of application No. 12/332,180, filed on Dec. 10, 2008, now abandoned.
Application No. 12/332,180 is a continuation-in-part of application No. 11/158,681, filed on Jun. 22, 2005, now abandoned.

(51) Int. Cl. G06Q 40/00

(52) U.S. Cl. 705/4; 705/36 T

(57) ABSTRACT

A system and method are disclosed for maximizing after-tax income from charitable remainder trusts, An evaluation service establishes a first charitable remainder trust that generates ordinary income from fixed income investments and a second charitable remainder trust that generates growth income from equity investments. The evaluation service further identifies a qualifying charitable organization. The evaluation service calculates a risk weight and distributes grantor assets between the first and second charitable remainder trusts based on the risk weight.

### CROSS-REFERENCES TO RELATED APPLICATIONS

This application is a continuation-in-part of and claims priority to U.S. patent application Ser. No. 12/332,180, filed on Dec. 10, 2008 and entitled “SYSTEM AND METHOD FOR MAXIMIZING AFTER-TAX INCOME USING SPLIT METHOD CHARITABLE REMAINDER TRUSTS,” where U.S. patent application Ser. No. 12/332,180 is a continuation-in-part of and claims priority to U.S. patent application Ser. No. 11/158,681, filed on Jun. 22, 2005 and entitled “SYSTEM AND METHOD FOR MAXIMIZING AFTER-TAX INCOME USING SPLIT METHOD CHARITABLE REMAINDER TRUSTS.”

### BACKGROUND OF THE INVENTION

1. Field of the Invention

The present invention relates to Charitable Remainder Trusts and more particularly to maximizing after-tax income using Charitable Remainder Trusts.

2. Description of the Related Art

Charitable Remainder Trusts (CRT) complying with Section 664 of the Internal Revenue Code often generate both ordinary income and growth income. A portion of income is distributed to one or more income beneficiaries and taxed depending on the type of income. For example, the ordinary income may be taxed at an income beneficiary's marginal tax rate while the growth income is taxed at a lower capital gains rate. Unfortunately, the income beneficiary may be unable to benefit from the lower tax rate of the growth income if the distribution entirely includes the ordinary income.

### SUMMARY OF THE INVENTION

From the foregoing discussion, there is a need for a system and method that maximizes CRT after-tax income. Beneficially, such a system and method would distribute a grantor's assets to accommodate risk tolerances of a grantor, income beneficiaries, and qualifying charitable organizations while maximizing after tax income.

The present invention has been developed in response to the present state of the art, and in particular, in response to the problems and needs in the art that have not yet been fully solved by currently available CRT funding methods. Accordingly, the present invention has been developed to provide a system and method for maximizing after-tax income that overcome many or all of the above-discussed shortcomings in the art.

A system of the present invention is presented to maximize after-tax income. The system, in one embodiment, includes a first CRT (CRT-1), a second CRT (CRT-2), a qualifying charitable organization, and an evaluation service. The CRT-1 generates ordinary income from fixed income investments. A first percentage of a value of the income investments is distributed to an income beneficiary and distributions are taxed under 26 United States Code (U.S.C.) section 664. The CRT-2 generates growth income from equity investments. A second percentage of a value of the equity investments is distributed to the income beneficiary and distributions are taxed under 26 U.S.C. section 664

The system further includes a computer readable storage medium storing executable code and a processor executing the executable code. The executable code comprises an evaluation service. The evaluation service calculates a risk weight w as w=(k₁x₁+k₂x₂+k₃x₃+k₄x₄)/100 where x₁ is the percentage of an annual income of the income beneficiary relative to total assets of a grantor, x₂ is a marginal tax rate of the income beneficiary, x₃ is a sensitivity of the income beneficiary to a reduction in distributions from the CRT-1 and the CRT-2 where 10=high, 0=low, x₄ is a percentage of an end of tax year tax liability for the income beneficiary relative to an annual income of the income beneficiary, and k₁=1.2, k₂=11, k₃=8, and k₄=2. The evaluation service further distributes w of funding assets of the grantor to the CRT-1 and 1−w of the funding assets to the CRT-2.

A method of the present invention is presented for maximizing after-tax income. In one embodiment, the method includes establishing a CRT-1, establishing a CRT-2, identifying a qualifying charitable organization, calculating a risk weight w, and distributing w of funding assets of the grantor to the CRT-1 and 1−w of the funding assets to the CRT-2. The risk weight w is calculated as w=(k₁x₁+k₂x₂+k₃x₃+k₄x₄)/100 where x₁ is the percentage of an annual income of the income beneficiary relative to total assets of a grantor, x₂ is a marginal tax rate of the income beneficiary, x₃ is a sensitivity of the income beneficiary to a reduction in distributions from the CRT-1 and the CRT-2 where 10=high, 0=low, x₄ is a percentage of an end of tax year tax liability for the income beneficiary relative to an annual income of the income beneficiary, and k₁=1.2, k₂=11, k₃=8, and k₄=2.

References throughout this specification to features, advantages, or similar language do not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram depicting one embodiment of a split investment combination of a Fixed Income Investment Charitable Remainder Trust (CRT-1) and an Equity Investment Charitable Remainder Trust (CRT-2);

FIG. 2 is a schematic block diagram depicting one embodiment of distribution system for trust income from the CRT-1 and CRT-2 during the lifetime of the grantor;

FIG. 3 is a schematic block diagram depicting one embodiment of a distribution system for trust assets following the death of the grantor;

FIG. 4 is a schematic flow chart diagram depicting one embodiment of a method for maximizing income to the grantor and income beneficiaries through use of a plurality of charitable remainder trusts and, upon the death of the grantor, passing the remainder of the estate to a charity;

FIG. 5 is a schematic block diagram depicting one embodiment of an apparatus configured to evaluate the distribution of assets between the CRT-1 and the CRT-2;

FIG. 6 is a schematic flow chart diagram depicting one embodiment of distributing assets of the present invention; and

FIG. 7 is a schematic block diagram depicting one embodiment of a computer of the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, specific details are provided. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

Individuals typically wish to minimize taxes on their assets and income, thus maximizing the amount available for themselves, their beneficiaries, and charitable giving. Various classes of trusts, including CRTs, provide an effective tax planning vehicle.

Under section 664 of the Internal Revenue Code, the source of income generation within a CRT determines how distributions will be treated in the hands of the trust's income beneficiary. Thus, distributions from a CRT generating ordinary income through fixed-income vehicles, such as CDs, government securities, mortgages, etc., will be taxed as ordinary income in the hands of the income beneficiary. Distributions from a CRT generating income through long term growth in equity investments will be taxed as capital gains in the hands of the income beneficiary. In a balanced or mixed investment CRT, all distributions will be taxed as ordinary income until the distributions have exhausted the portion of the trust income generated by fixed income investments. Only then will the beneficiaries receive the benefit of the substantially lower capital gains rate on the distributions that they receive, even if equity investments generate a substantial portion of the trust income or growth. Under currently regulations, neither the grantor nor the beneficiaries can exercise control over the percentage of distributions taxed as fixed income and as capital gains. If the fixed income investments supply income sufficient to cover the distributions, the grantor and other beneficiaries may never enjoy the benefit of the lower capital gains tax rate. The current invention provides a system and method for administering trusts so as to give the grantor greater control over the taxing of distributions. The drawings depict one embodiment of the system and method.

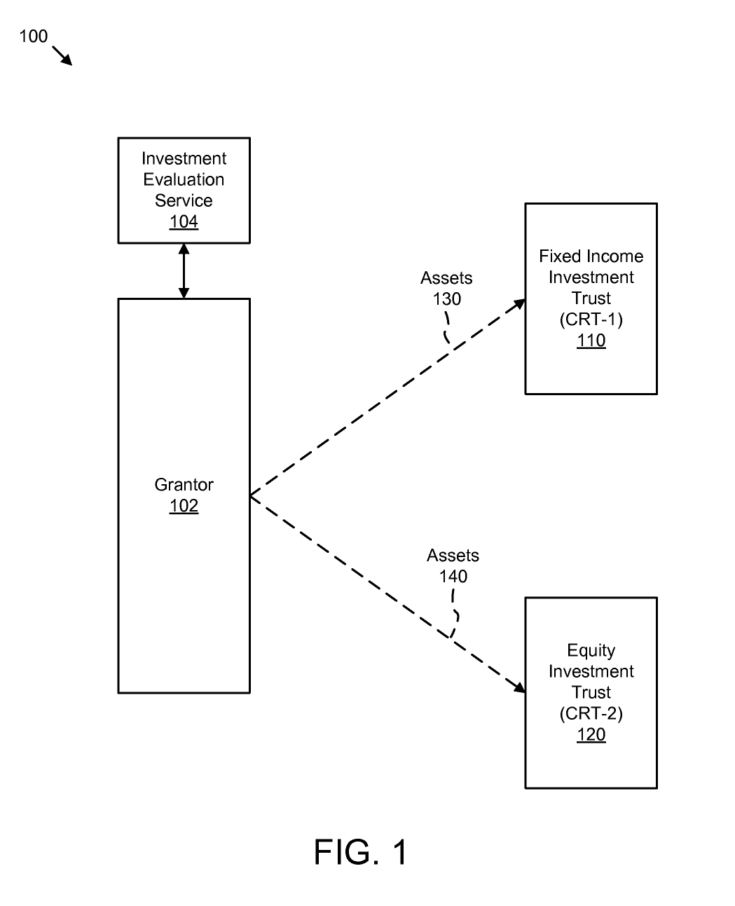

FIG. 1 is a schematic block diagram depicting one embodiment of split investment combination 100 of a Fixed Income Investment Trust (“CRT-1”) 110 and an Equity Investment Trust (“CRT-2”) 120. As depicted, the combination 100 includes a grantor 102, an investment evaluation service 104, a CRT-1 110, a CRT 2 120, assets 130 and assets 140. The grantor 102 is understood to include any investment advisor, financial service, trustee, or other representative of the grantor.

The investment evaluation service 104 analyzes the relative income and risk potential of fixed income investments and equity investments and combines these with information regarding the risk/benefit preferences of the grantor 102. The investment evaluation service 104 advises the grantor 102 regarding the distribution of assets 130, 140. The grantor 102 distributes assets 130 and 140 between the trusts according to preference. In so doing, the grantor 102 balances the lower risk, fixed earning rate and higher tax rate of the ordinary income investment type CRT-1 110 with the higher risk, variable growth rate, and lower tax rate of the equity or capital gain investment type CRT-2 120. Because the two income type generation mechanisms are separated into two CRTs, rather than combined in one, the grantor 102 may be sure that at least a portion of distributions will enjoy the lower capital gains tax rate.

In a further embodiment, the grantor 102 establishes CRT-1 110 and CRT-2 120 as charitable remainder annuity trusts (CRAT), wherein distributions are calculated as a percentage of the original value of the trust assets 130, 140. In a further embodiment, the grantor 102 establishes CRT-1 110 and CRT-2 120 as charitable remainder unitrusts (CRUT) wherein distributions are calculated as a percentage of the annual value of the trust assets. Alternatively, the grantor 102 may establish one of CRT-1 110 and CRT-2 120 as a CRAT and the other as a CRUT. In so doing, the grantor 102 considers the relative risk and earning capacity of fixed income and equity investments. For example, the grantor 102 may establish the lower risk and fixed earning fixed income trust as a CRAT, yielding fixed distribution income while gradually increasing the asset value of the trust and establish the higher risk, variable earning equity investment trust as a CRUT, which pays out higher income distributions as the trust corpus increases, but preserves the trust corpus by paying lower income distributions if the corpus diminishes. In one embodiment, one of the CRTs is an insurance trust funded with a wealth replacement life insurance policy.

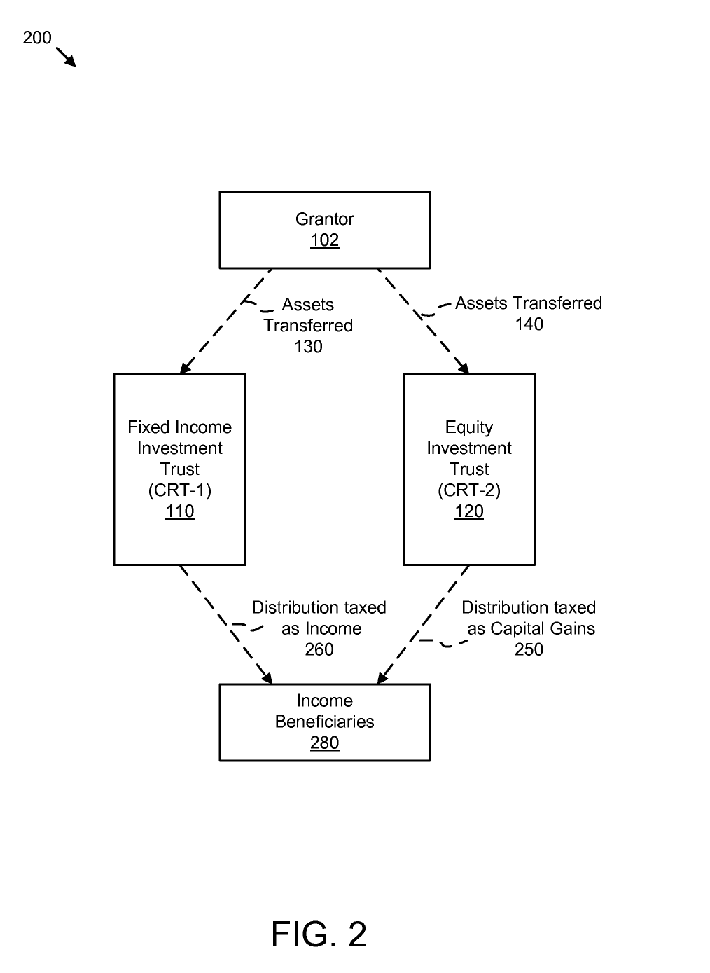

FIG. 2 is a schematic block diagram depicting one embodiment of a distribution system 200 for trust income from the CRT-1 110 and the CRT-2 120 during the lifetime of the grantor 102. As depicted, the distribution 200 comprises the grantor 102, the CRT-1 110, the CRT-2 120, assets transferred 130 and 140, an income distribution 260, a capital gains distribution 250, and one or more income beneficiaries 280. In one embodiment, the grantor 102 is also the income beneficiaries 280. The description of FIG. 2 refers to elements of FIG. 1, like numbers referring to like elements.

The grantor 102 funds the CRT-1 110 and the CRT-2 120 with asset transfers 130. The CRT-1 110 and CRT-2 120 hold the income producing assets that are transferred 130. Distributions 260 from the CRT-1 110 to the income beneficiaries 280 are taxed as ordinary income. Distributions 250 from the CRT-2 120 to the income beneficiaries 280 are taxed as long-term capital gains income. In one embodiment, the grantor 102 is also an income beneficiary 280.

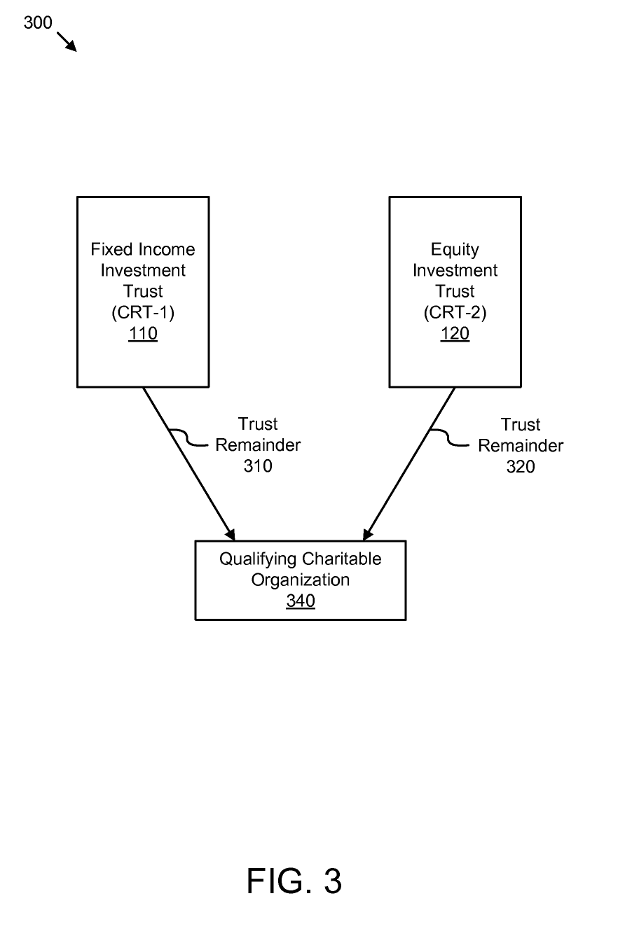

FIG. 3 is a schematic block diagram depicting one embodiment of a distribution system 300 for trust assets following the death of the grantor 102 or other triggering event. The description of FIG. 3 refers to elements of FIGS. 1-2, like numbers referring to like elements. As depicted, the distribution system 300 comprises a CRT-1 110, a CRT-2 120, a CRT-1 trust remainder 310, a CRT-2 trust remainder 320, and a qualifying charitable organization 340.

Upon the death of the grantor 102, or another triggering event, the assets remaining in the CRT-1 110 and the CRT-2 120 flow tax-free to the qualifying charitable organization 340, which may be a family foundation or other qualifying charitable organization.

The grantor 102 may establish a period of years or other triggering event for termination of the CRT-1 110 and CRT-2 120, and the ensuing payout of trust remainders 310 and 320. In a further embodiment, the trust remainders 310 and 320 may remain in the CRT-1 110 and CRT-2 120 to be used for qualifying charitable purposes.

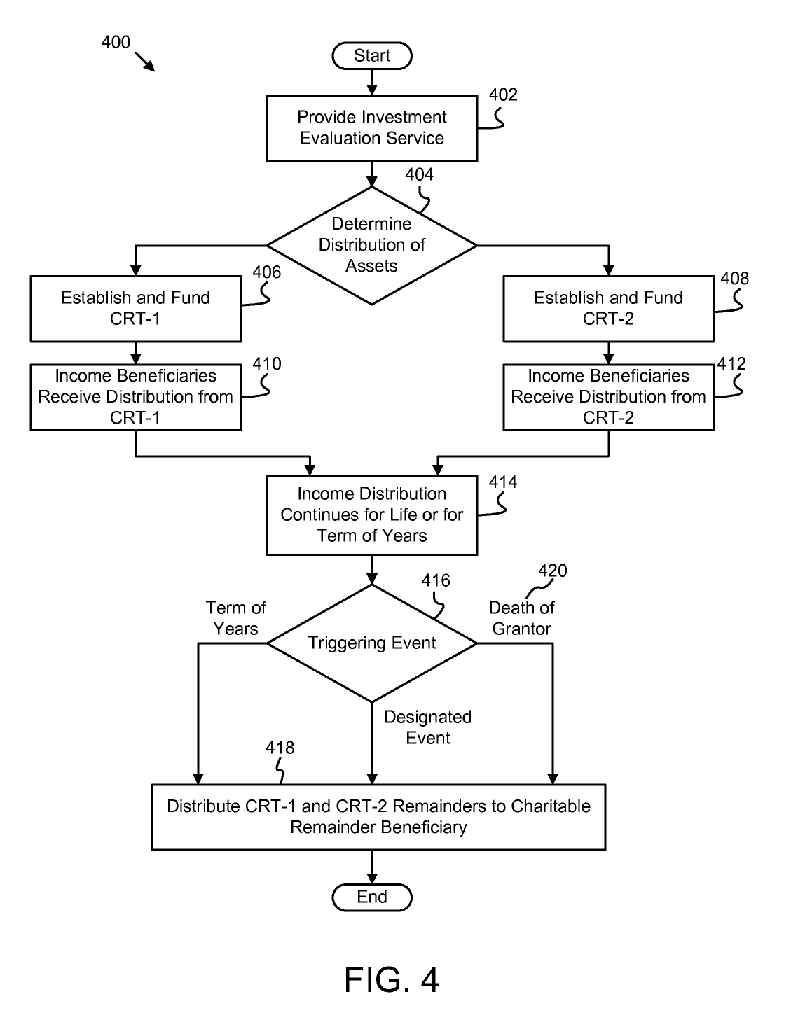

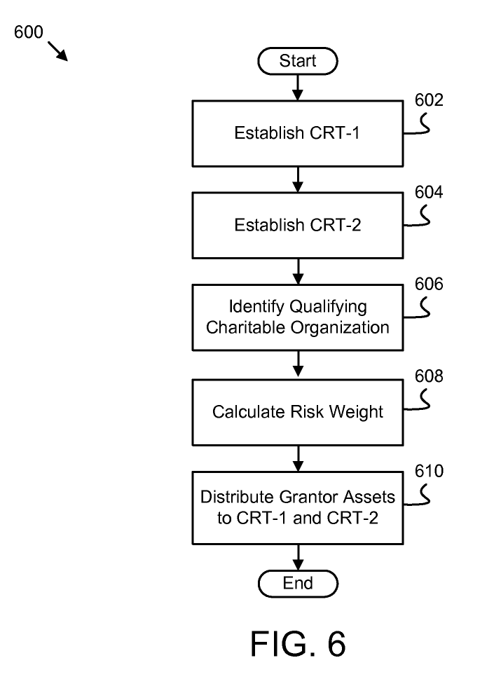

FIG. 4 is a schematic flow chart diagram depicting one embodiment of a method 400 for maximizing income to the grantor 102 through use of a plurality of charitable remainder trusts 110, 120, and, upon the death of the grantor 102, passing the remainder of the estate to a charity. The description of the method 400 refers to elements of FIGS. 1-3, like numbers referring to like elements. As depicted, the method 400 includes establishing 418 a qualifying charitable organization 340, providing 402 an investment evaluation service, and determining 404 the distribution of assets 130 and 140 between the CRT-1 110 and the CRT-2 120. The determination 404 of the distribution of assets is described in FIG. 6. The method 400 further comprises establishing and funding 406 a CRT-1 110, establishing and funding 408 a CRT-2 120, receiving 410 income beneficiary distributions 260 from the CRT-1 110, receiving 412 income beneficiary distributions 260 from the CRT-2-120, income distribution continues 414 for life or for terms of years, the triggering event 416, distributing 418 the CRT-1 remainder 310 to the qualifying charitable organization 340, and the CRT-2 remainder 320 to the qualifying charitable organization 340, the death 420 of the grantor 102.

Considerations such as risk, growth rate, and tax rate may influence the distribution of assets 130 and 140 between the CRT-1 110 and the CRT-2 120. Risk and growth considerations may also influence the establishment of the trusts as CRUTs, CRATs, or a combination of both.

The grantor 102 may designate a family foundation or other qualifying charitable organization 380 to receive the trust remainders 310 and 320. In a further embodiment, an event other than the death 420 of the grantor 102, such as a term of years, may trigger distribution of the trust remainders 310 and 320. Alternatively, the triggering event may convert CRT-1 110 and CRT-2 120 to qualifying charitable organizations 380 or qualifying charitable purposes rather than dissolving the CRTs 110 and 120 and distributing the remainders 310 and 320.

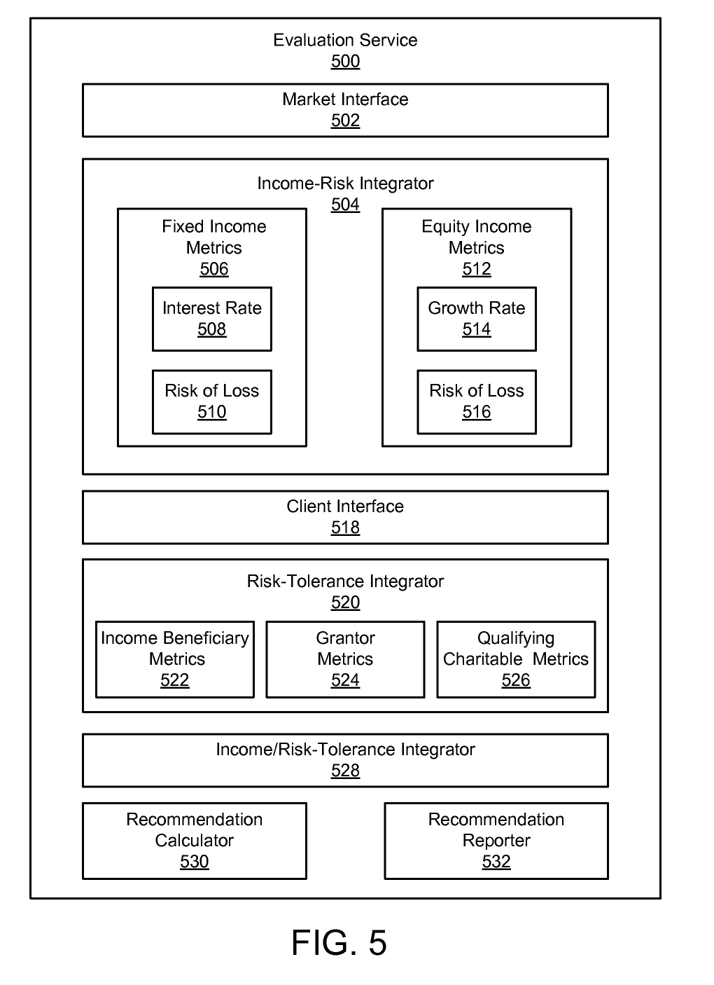

FIG. 5 is a schematic block diagram depicting one embodiment of an evaluation service apparatus 500 configured to evaluate the distribution of assets between the CRT-1 110 and the CRT-2 120. As depicted, the apparatus 500 comprises a market interface 502, an income risk integrator 504, fixed income metrics 506, including an interest rate 508 and a risk of loss 510, equity investment metrics 512, including a growth rate 514 and a risk of loss 516, a client interface 518, a risk-tolerance integrator 520, including income beneficiary metrics 522, grantor metrics 524, and charitable remainder beneficiary metrics 526, and income-risk/risk-tolerance integrator 528, and recommendation calculator 530, and a recommendation reporter 532.

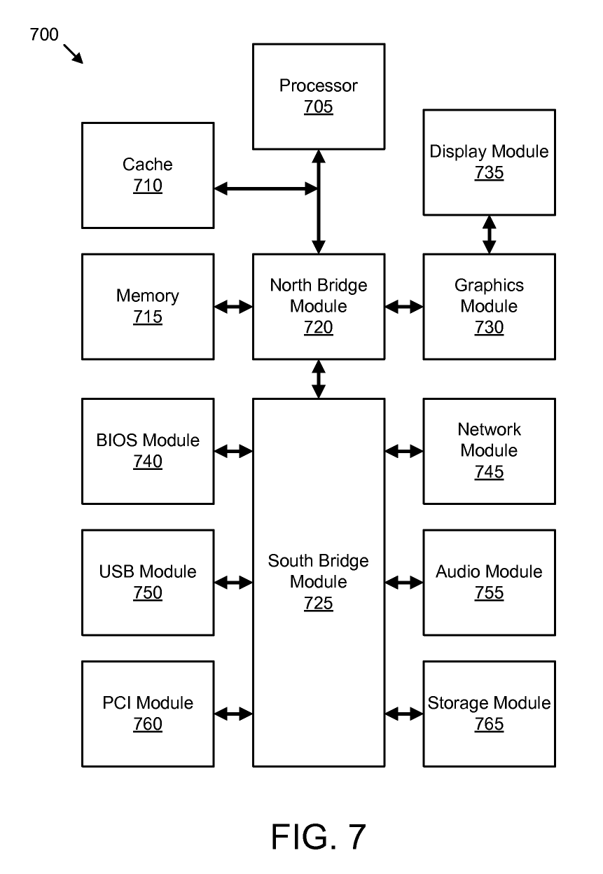

In various embodiments, the apparatus 500 may comprise a computer readable storage medium storing executable code that is executed on a processor of computer hardware that will be described hereafter in FIG. 7. The executable code may include the market interface 502, income risk integrator 504, fixed income metrics 506, interest rate 508, risk of loss 510, equity investment metrics 512, growth rate 514, risk of loss 516, client interface 518, risk-tolerance integrator 520, income beneficiary metrics 522, grantor metrics 524, charitable remainder beneficiary metrics 526, income-risk/risk-tolerance integrator 528, recommendation calculator 530, and a recommendation reporter 532. The apparatus 500 may further comprises computer displays, input devices, printers, networks, and the like.

In the depicted embodiment, the market interface 502 supplies investment data to the income-risk integrator 504. The data may include income potential such as interest rates 508 for fixed income investments and growth rates 514 for equity investments. The data may also include the risk of loss 510 and 516, as established by a range of analysts and reporting agencies for each of the investments. The income-risk integrator 504 analyzes and integrates the data 506 and 512 for the fixed income and equity investments, respectively, and calculates a current risk benefit indicator for each class of investment. The income-risk integrator 504 then passes the indicators to the income/risk-tolerance integrator 528.

The client interface 518 receives income beneficiary metrics 522, grantor metrics 524, and qualifying charitable organization metrics 526 from the relevant entities. The metrics 522, 524, and 526 may include an annual income of the income beneficiary 280, total assets of the grantor 102, a marginal tax rate of the income beneficiary 280, a sensitivity of the income beneficiary 280 to a reduction in distributions from the CRT-1 110 and the CRT-2 120, an end of tax year tax liability for the income beneficiary 280, and an annual income of the income beneficiary 280. The client interface 518 passes the information to the risk-tolerance integrator 520. The risk-tolerance integrator 520 analyzes the metrics 522, 524, and 526, and calculates a percentage of an annual income of the income beneficiary 280 relative to total assets of a grantor 102 x₁, a marginal tax rate of the income beneficiary 280 x₂, a sensitivity of the income beneficiary 280 to a reduction in distributions from the CRT-1 110 and the CRT-2 120 x₃, where 10 is high, 0 is low, and a percentage of an end of tax year tax liability for the income beneficiary 280 relative to an annual income of the income 280 beneficiary x₄.

The income/risk-tolerance integrator 528 analyzes the investment indicator calculated by the income-risk integrator 504 and x₁, x₂, x₃, and x₄ calculated by the risk-tolerance integrator 520 and calculates a risk weight w. The risk weight w increases as the income beneficiaries 280 and/or grantor 102 are more risk averse.

The recommendation calculator 530 distributes total grantor funding between CRT-1 110 and CRT-2 120. In one embodiment the recommendation calculator 530 distributes assets 130 equal to w times the total grantor funding of the CRT-1 110 and the CRT-2120 to the CRT-110 and assets 140 equal to (1−w) times the total grantor funding of CRT-110 and the CRT-2 120 to the CRT-2 120. The recommendation calculator 530 may pass the distribution of assets 130, 140 to the recommendation reporter 532, which passes the distribution to the client interface 518.

FIG. 6 is a schematic flow chart diagram depicting one embodiment of a method 600 distributing assets of the present invention. The method 600 substantially includes the steps to carry out the functions presented above with respect to the operation of the described apparatus 500 of FIG. 5. In one embodiment, the method 600 is implemented with a computer readable storage medium comprising executable code stored on a tangible storage device. The computer readable storage medium may be integrated into a computing system, such as the computer of FIG. 7, wherein the executable code executed by the computing system performs the method 600.

The evaluation service apparatus 500 establishes 602 the CRT-1 110 as described for step 406 of FIG. 4. The CRT-1 110 generates ordinary income from fixed income investments. A first percentage of a value of the income investments is distributed to the income beneficiary 280 and distributions are taxed under 26 U.S.C. section 664.

The evaluation service apparatus 500 further establishes 604 the CRT-2 120 that generates growth income from equity investments as described for step 408 of FIG. 4. A second percentage of a value of the equity investments is distributed to the income beneficiary 280 and distributions are taxed under 26 U.S.C. section 664. In one embodiment, the first percentage is equal to the second percentage. In an alternate embodiment, the first percentage is greater than the second percentage.

The evaluation service apparatus 500 further identifies 606 the qualifying charitable organization 340. The qualifying charitable organization 340 may be organized to satisfy the requirements of 26 U.S.C. section 664. Alternately, the qualifying charitable organization 340 may be selected by the grantor 102 and identified 606 as satisfying the requirements of 26 U.S.C. section 664. The qualifying charitable organization 340 is designated as a remainderman of the CRT-1 110 and the CRT-2 120.

The evaluation service apparatus 500 calculates 608 the risk weight w. In one embodiment, the risk weight w is calculated 608 using Equation 1, where x₁ is the percentage of the annual income of the income beneficiary relative to the total assets of the grantor, x₂ is the marginal tax rate of the income beneficiary, x₃ is the sensitivity of the income beneficiary to a reduction in distributions from the CRT-1 110 and the CRT-2 120 where 10=high, 0=low, x₄ is the percentage of the end of tax year tax liability for the income beneficiary relative to an annual income of the income beneficiary, and k₁, k₂, k₃, and are constants. In one embodiment, k₁ is in the range 0.5 to 2, k₂ is in the range of 8 to 16, k₃ is in the range of 6 to 9, and k₄ is in the range of 1.5 to 3. In a certain embodiment, k₁=1.2, k₂=11, k₃=8, and k₄=2.

w=(k₁x₁+k₂x₂+k₃x₃+k₄x₄)/100 Equation 1

In one embodiment, x₃ is determined from a response x₅ to a first question “How many months over a five year period are you willing to lose money in order to achieve a higher average return?” where x₅ is a number of months in the five year period. For example, if the grantor 102 responds “ten months” to the first question, then x₅=10.

In addition, x₃ may be determined from a response x₆ to a second question “How many months is acceptable to liquidate your investment?” where x₆ is a number of months needed to completely liquidate assets in the CRT-1 110 and the CRT-2 120. For example, if the grantor 102 responds “two months” to the second question indicating that the grantor wants to be able to sell the assets of the CRT-1 110 and the CRT-2 120 for cash within two months, then x₆=2.

In one embodiment, x₃ is determined from a response x₇ to a third question “How many consecutive months are you willing to NOT receive income from the CRT-1 and the CRT-2 in order to achieve a higher average return?” where x₇ is a number of months without income for the CRT-1 110 and the CRT-2 120. For example, if the grantor 102 indicates that the grantor 102/income beneficiary 280 is willing to not receive income from either the CRT-1 110 or the CRT-2 120 for twelve months, then x₇=12. In one embodiment, the first, second, and third questions are asked to the grantor 102. Alternatively, the first, second, and third questions are asked to the income beneficiaries 280.

The evaluation service apparatus 500 distributes 610 the funding assets of the grantor based on the risk weight w. In one embodiment, the evaluation service apparatus 5100 distributes 610 w times the total funding assets of the grantor 102 to the CRT-1 110 and (1−w) times the total funding assets of the grantor to the CRT-2 120. For example, if the risk weight w is 0.6 and the total funding assets is ten million dollars ($10,000,000), the evaluation service apparatus 500 distributes six million dollars ($6,000,000) to CRT-1 110 and four million dollars ($4,000,000) to CRT-2 120. In an alternate embodiment, the evaluation service apparatus 5100 distributes 610 w times the funding assets of the grantor 102 to the CRT-1 110 and (1−√w) times the funding assets of the grantor to the CRT-2 120 where using the square root of the risk weight increases the sensitivity to risk.

By calculating 608 the risk weight w, the method 600 accounts for the grantor 102/income beneficiaries 280 sensitivity to risk in distributing 610 assets between the CRT-1 110 and the CRT-2 120. The distribution 610 of the assets between the CRT-1 110 and the CRT-2 120 may reduce the tax liability of the income beneficiaries 280 by allowing income from the CRT-2 120 to be taxed at a lower capital gains tax rate.

FIG. 7 is a schematic block diagram illustrating one embodiment of a computer 700 of the present invention. The computer 700 may embody the apparatus 500 of FIG. 5. The description of the computer 700 refers to elements of FIGS. 1-6, like numbers referring to like elements. The computer 700 includes a processor 705, a cache 710, a memory 715, a north bridge module 720, a south bridge module 725, a graphics module 730, a display module 735, a basic input/output system (BIOS) module 740, a network module 745, a universal serial bus (USB) module 750, an audio module 755, a peripheral component interconnect (PCI) module 760, and a storage module 765.

The processor 705, cache 710, memory 715, north bridge module 720, south bridge module 725, graphics module 730, display module 735, BIOS module 740, network module 745, USB module 750, audio module 755, PCI module 760, and storage module 765, referred to herein as components, may be fabricated of semiconductor gates on one or more semiconductor substrates. Each semiconductor substrate may be packaged in one or more semiconductor devices mounted on circuit cards. Connections between the components may be through semiconductor metal layers, substrate-to-substrate wiring, circuit card traces, and/or wires connecting the semiconductor devices.

The memory 715 stores executable code. The memory 715 may be the computer readable storage medium. The processor 705 executes the executable as is well known to those skilled in the art. The executable code may be tangibly stored in the storage module 765. The storage module 765 may be the computer readable storage medium. The storage module 765 may be a hard disk drive, an optical storage device, a holographic storage device, a micromechanical storage device, a semiconductor storage device, or the like.

The processor 705 may communicate with the cache 710 through a processor interface bus to reduce the average time to access memory 715. The cache 710 may store copies of the data from the most frequently used memory 715 locations. The computer 700 may use one or more caches 710 such as a Double Data Rate 2 (DDR2) cache memory or the like.

The north bridge module 720 may communicate with and provide bridging functionality between the processor 705, the graphic module 730, the memory 715, and the cache 710. The processor 705 may be connected to the north bridge module 720 over a, for example, six hundred sixty seven Megahertz (667 MHz) front side bus.

The north bridge module 720 may be connected to the south bridge module 725 through a direct media interface (DMI) bus. The DMI bus may provide a high-speed, bi-directional, point-to-point link supporting a clock rate for example of one Gigabytes per second (1 GBps) in each direction between the north bridge module 720 and the south bridge module 725. The south bridge module 725 may support and communicate with the BIOS module 740, the network module 745, the PCI module 760, and the storage module 765.

The PCI module 760 may communicate with the south bridge module 725 for transferring data or power to peripheral devices. The PCI module 760 may include a PCI bus for attaching the peripheral devices. The PCI bus can logically connect several peripheral devices over the same set of connections. The peripherals may be selected from a printer, a joystick, a scanner, or the like. The PCI module 760 may also comprise an expansion card as is well known to those skilled in the art.

The BIOS module 740 may communicate instructions through the south bridge module 725 to boot the computer 700, so that computer readable software instructions stored on the storage module 765 can load, execute, and assume control of the computer 700. Alternatively, the BIOS module 740 may comprise a coded program embedded on a chipset that recognizes and controls various devices that make up the computer 700.

The network module 745 may communicate with the south bridge module 725 to allow the computer 700 to communicate with other devices over a network. The devices may include routers, bridges, computers, printers, and the like.

The display module 735 may communicate with the graphic module 730 to display information as will be described hereafter. The display module 735 may be a cathode ray tube (CRT), a liquid crystal display (LCD) monitor, or the like. The USB module 750 may communicate with one or more USB compatible devices over a USB bus. The audio module 755 may generate an audio output.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A system for maximizing after-tax income on distributions from a Charitable Remainder Trusts (CRT), the system comprising:
a first class of CRT (CRT-1) generating ordinary income from fixed income investments, wherein a first percentage of a value of the income investments is distributed to an income beneficiary and distributions are taxed under 26 United States Code (U.S.C.) section 664;
a second class of CRT (CRT-2) generating growth income from equity investments, wherein a second percentage of a value of the equity investments is distributed to the income beneficiary and distributions are taxed under 26 U.S.C. section 664;
a qualifying charitable organization designated as a remainderman of the CRT-1 and CRT-2;
a computer readable storage medium storing executable code;
a processor executing the executable code, the executable code comprising
an evaluation service calculating a risk weight was w=(k₁x₁+k₂x₂+k₃x₃+k₄x₄)/100 where x₁ is a percentage of an annual income of the income beneficiary relative to total assets of a grantor, x₂ is a marginal tax rate of the income beneficiary, x₃ is a sensitivity of the income beneficiary to a reduction in distributions from the CRT-1 and the CRT-2 where 10=high, 0=low, x₄ is a percentage of an end of tax year tax liability for the income beneficiary relative to an annual income of the income beneficiary, and k₁=1.2, k₂=11, k₃=8, and k₄=2, and distributing w of funding assets of the grantor to the CRT-1 and 1−w of the funding assets to the CRT-2.

2. The system of claim 1, wherein x₃ is determined from a response x₅ to a first question “How many months over a five year period are you willing to lose money in order to achieve a higher average return?”

3. The system of claim 2, wherein x₃ is determined from a response x₆ to a second question “How many months is acceptable to liquidate your investment?”

4. The system of claim 3, wherein x₃ is determined from a response x₇ to a third question “How many consecutive months are you willing to NOT receive income from the CRT-1 and the CRT-2 in order to achieve a higher average return?”

5. The system of claim 4, wherein x₃ is calculated as 10/(k₅x₅+k₆x₆+k₇x₇).

6. The system of claim 1, wherein the qualifying charitable organization is a family foundation.

7. The system of claim 1, wherein the CRT-1 and CRT-2 become active charitable vehicles following an event otherwise triggering dissolution of the CRT-1 and the CRT-2 and distribution of the remainder to a qualifying charitable organization.

8. The system of claim 1, wherein the CRT-1 comprises an individual trust and the CRT-2 comprises an individual trust.

9. The system of claim 1, wherein the CRT-1 and CRT-2 are selected from the group consisting of a charitable remainder unitrust and a charitable remainder annuity trust.

10. The system of claim 1, wherein at least one CRT is an insurance trust funded with a wealth replacement life insurance policy.

11. A method performed by a computer readable storage medium storing executable code executed by a process that maximizes after-tax income on distributions from Charitable Remainder Trusts (CRT), the method comprising:
establishing a first class of CRT (CRT-1) generating ordinary income from fixed income investments, wherein a first percentage of a value of the income investments is distributed to an income beneficiary and distributions are taxed under 26 United States Code (U.S.C.) section 664;
establishing a second class of CRT (CRT-2) generating growth from equity investments, wherein a second percentage of a value of the equity investments is distributed to the income beneficiary and distributions are taxed under 26 U.S.C. section 664;
identifying a qualifying charitable organization designated as a remainderman of the CRT-1 and CRT-2;
calculating a risk weight w as w=(k₁x₁+k₂x₂+k₃x₃+k₄x₄)/100 where x₁ is a percentage of an annual income of the income beneficiary relative to total assets of a grantor, x₂ is a marginal tax rate of the income beneficiary, x₃ is a sensitivity of the income beneficiary to a reduction in distributions from the CRT-1 and the CRT-2 where 10=high, 0=low, x₄ is a percentage of an end of tax year tax liability for the income beneficiary relative to an annual income of the income beneficiary, and k₁=1.2, k₂=11, k₃=8, and k₄=2; and
distributing w of funding assets of the grantor to the CRT-1 and 1−w of the funding assets to the CRT-2.

12. The method of claim 11, wherein x₃ is determined from a response x₅ to a first question “How many months over a five year period are you willing to lose money in order to achieve a higher average return?”

13. The method of claim 12, wherein x₃ is determined from a response x₆ to a second question “How many months is acceptable to liquidate your investment?”

14. The method of claim 13, wherein x₃ is determined from a response x₇ to a third question “How many consecutive months are you willing to NOT receive income from the CRT-1 and the CRT-2 in order to achieve a higher average return?”

15. The method of claim 14, wherein x₃ is calculated as 10/(k₅x₅+k₆x₆+k₇x₇).

16. The method of claim 11, wherein the qualifying charitable organization is a family foundation.

17. The method of claim 11, wherein the CRT-1 and CRT-2 become active charitable vehicles following an event otherwise triggering dissolution of the CRT-1 and the CRT-2 and distribution of the remainder to a qualifying charitable organization.

18. The method of claim 11, wherein the CRT-1 comprises an individual trust and the CRT-2 comprises an individual trust.

19. The method of claim 11, wherein the CRT-1 and CRT-2 are selected from the group consisting of a charitable remainder unitrust and a charitable remainder annuity trust.

20. The method of claim 11, wherein at least one CRT is an insurance trust funded with a wealth replacement life insurance policy.
